(19) United States
(12) Patent Application Publication
(10) Pub. No.: US 2024/0286868 A1
(43) Pub. Date: Aug. 29, 2024

(54) SYSTEM FOR A TRANSPORT SYSTEM COMPRISING AN ELEVATOR, AN ESCALATOR OR A MOVING WALK

(71) Applicant: KONE Corporation, Helsinki (FI)

(72) Inventors: Mika BELOV, Helsinki (FI); Mikko PIIRONEN, Helsinki (FI)

(73) Assignee: KONE Corporation, Helsinki (FI)

(21) Appl. No.: 18/656,674

(22) Filed: May 7, 2024

Related U.S. Application Data
(63) Continuation of application No. PCT/EP2021/080913, filed on Nov. 8, 2021.

(51) Int. Cl. B66B 1/34; B66B 5/00; B66B 25/00

(52) U.S. Cl. CPC B66B 1/3453; B66B 1/3461; B66B 5/0012; B66B 5/0018; B66B 25/006

(57) ABSTRACT

In a communication system of a transport system including an elevator, an escalator or a moving walk, a control unit may be configured to control data transmission between at least one uplink communication interface and a plurality of downlink communication interfaces of a networking node. The control unit may be configured to obtain an event necessitating data transmission control between the at least one uplink communication interface and the plurality of downlink communication interfaces. The control unit may be configured to reduce the amount of data transmitted between at least one uplink communication interface and at least one of the plurality of downlink communication interfaces based on the event.

### TECHNICAL FIELD

The present application relates to the field of a communication system of a transport system.

### BACKGROUND

Traditionally, a communication system of a transport system, i.e. a communication system interconnecting applications and devices (for example, controllers, sensors, actuators etc.) of an elevator system, an escalator system or a moving walk, have been implemented with building automation networks, such as a controller area network (CAN) or a local operating network (LON). This may also lead to a situation in which there are a plurality of separate communication systems with different protocol stacks and gateways within the same transport system.

When new devices or applications, for example, info screens, that need an access to external or remote data resources, separate data links may have to be built by adding, for example, dedicated cabling or subscriber identity module (SIM) card to the communication system. This results in a complicated and an expensive system, which is laborious to modify and maintain.

One possible solution for simplifying the structure of the communication system of the transport system is to connect separate applications and devices into a unified single protocol stack communication system using a shared communication medium such that messages from various devices and applications will travel through a shared bus segment or segments. This, however, may result in a challenge how to ensure operability of critical applications and devices in case of an operational anomaly of the communication system of the transport system.

### SUMMARY

According to a first aspect, there is provided a system for a transport system comprising an elevator, an escalator or a moving walk. The system comprises a networking node comprising at least one uplink communication interface and a plurality of downlink communication interfaces, at least one data node, wherein one or more data nodes are connected to each of the plurality of downlink communication interfaces, and a control unit communicatively connected to the networking node. The control unit is configured to control data transmission between the at least one uplink communication interface and the plurality of downlink communication interfaces. The control unit is configured to obtain an event necessitating data transmission control between the at least one uplink communication interface and the plurality of downlink communication interfaces, and reduce the amount of data transmitted between at least one uplink communication interface and at least one of the plurality of downlink communication interfaces based on the event.

In an implementation form of the first aspect, the event is an external event received by the control unit.

In an implementation form of the first aspect, the event in an internal event associated with the system.

In an implementation form of the first aspect, the control unit is configured to obtain the event from a diagnostics controller.

In an implementation form of the first aspect, the event is a power supply failure.

In an implementation form of the first aspect, the control unit is configured detect a state of a backup battery associated with the system and to reduce the amount of data transmitted between uplink communication interface and at least one of the plurality of downlink communication interfaces based on the state of the backup battery.

In an implementation form of the first aspect, the backup battery is an internal battery of the networking node.

In an implementation form of the first aspect, the system further comprises a memory connected to the control unit, the memory being configured to store priority data. The control unit is configured to reduce the amount of data transmitted between at least one uplink communication interface and at least one of the plurality of downlink communication interfaces based on the event and the priority data stored in the memory.

In an implementation form of the first aspect, the priority data comprises a specific priority assigned to each downlink communication interface.

In an implementation form of the first aspect, the priority data comprises a specific priority assigned to each data node.

In an implementation form of the first aspect, the control unit is configured to receive the priority data from a diagnostics controller.

In an implementation form of the first aspect, the control unit is configured to interrupt data transmission between at least one of the plurality of downlink communication interfaces and at least one uplink communication interface.

In an implementation form of the first aspect, the plurality of downlink communication interfaces are configured in at least two modules, and the control unit is configured to reduce the amount of data transmitted between at least one uplink communication interface and at least one of the plurality of downlink communication interfaces based on the event by module basis.

In an implementation form of the first aspect, the control unit is configured to reduce the amount of data transmitted between at least one uplink communication interface and at least one of the plurality of downlink communication interfaces periodically.

In an implementation form of the first aspect, the at least one data node comprises an intercom device, a media screen, a surveillance equipment, a node that mainly provides information to a passenger, a node that mainly transmits information, and a node that both transmits and receives information.

In an implementation form of the first aspect, the networking node is arranged in an elevator car and an uplink communication interface is connected to a communication bus segment arranged in a travelling cable.

In an implementation form of the first aspect, the control unit is configured to obtain information indicating a presence of an object in the elevator car, and take the presence of the object in the elevator car into account when reducing the amount of data transmitted between at least one uplink communication interface and at least one of the plurality of downlink communication interfaces.

In an implementation form of the first aspect, an uplink communication interface comprises a wireless uplink communication interface.

In an implementation form 1 of the first aspect, a downlink communication interface comprises a wireless downlink communication interface.

In an implementation form of the first aspect, the control unit is configured to disable the wireless downlink communication interface when the amount of transmitted data needs to be reduced based on the obtained event.

According to a second aspect, there is provided a communication system of a transport system comprising an elevator, an escalator or a moving walk. The communication system comprises the system of the first aspect.

In an implementation form of the second aspect, the communication system further comprises a diagnostics controller communicatively connected to the control unit.

In an implementation form of the second aspect, the diagnostics controller is configured to determine a power failure associated with the communication system, and transmit an indication of the power failure to the system.

In an implementation form of the second aspect, the diagnostics controller is configured to determine priorities associated with the at least one data node, and transmit the priorities to the control unit for storing by the control unit.

In an implementation form of the second aspect, the diagnostics controller is configured to determine a communication overload in the communication system, and transmit an indication of the communication overload to the control unit.

According to a third aspect, there is provided a transport system comprising the communication system the second aspect, wherein the transport system comprises an elevator, an escalator or a moving walk.

According to a fourth aspect, there is provided a method for a communication system of a transport system comprising an elevator, an escalator or a moving walk. The method comprises controlling data transmission between at least one uplink communication interface and a plurality of downlink communication interfaces of a networking node; obtaining an event necessitating data transmission control between the at least one uplink communication interface and the plurality of downlink communication interfaces; and reducing the amount of data transmitted between at least one uplink communication interface and at least one of the plurality of downlink communication interfaces based on the event.

According to a fifth aspect, there is provided a computer program comprising instructions for causing a control unit to perform at least the following: controlling data transmission between at least one uplink communication interface and a plurality of downlink communication interfaces of a networking node; obtaining an event necessitating data transmission control between the at least one uplink communication interface and the plurality of downlink communication interfaces; and reducing the amount of data transmitted between at least one uplink communication interface and at least one of the plurality of downlink communication interfaces based on the event.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1A illustrates a system for a transport system according to an example embodiment.

FIG. 1B illustrates a system for a transport system according to an example embodiment.

FIG. 1C illustrates a system for a transport system according to another example embodiment.

FIG. 1D illustrates a system for a transport system according to an example embodiment.

FIG. 1E illustrates a system for a transport system according to an example embodiment.

FIG. 1F illustrates a system for a transport system according to an example embodiment.

FIG. 1G illustrates a communication system for a transport system according to an example embodiment.

FIG. 2 illustrates a method for a transport system comprising an elevator, an escalator or a moving walk according to an example embodiment.

FIG. 3 illustrates an example of an apparatus configured to practice one or more example embodiments.

### DETAILED DESCRIPTION

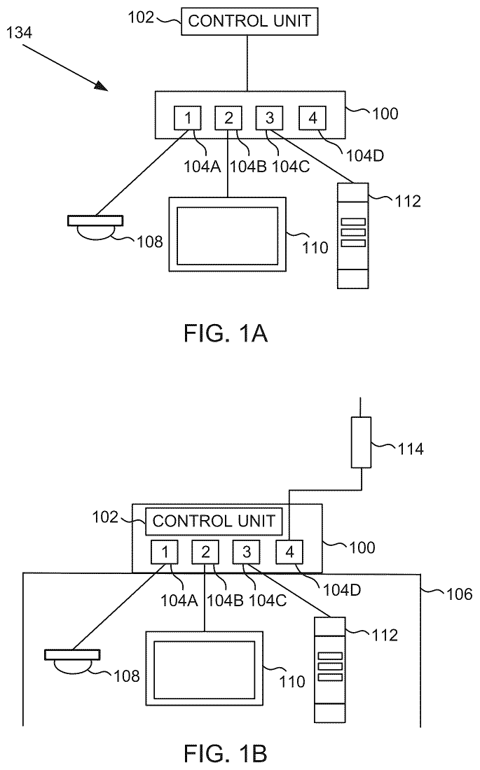

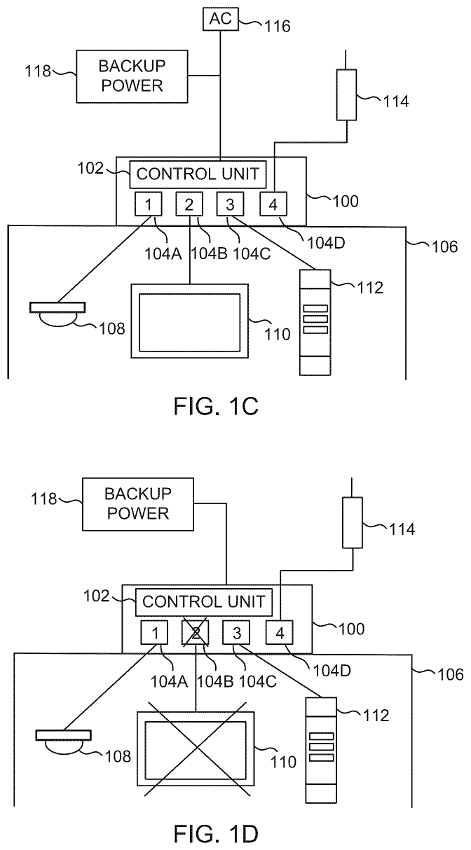

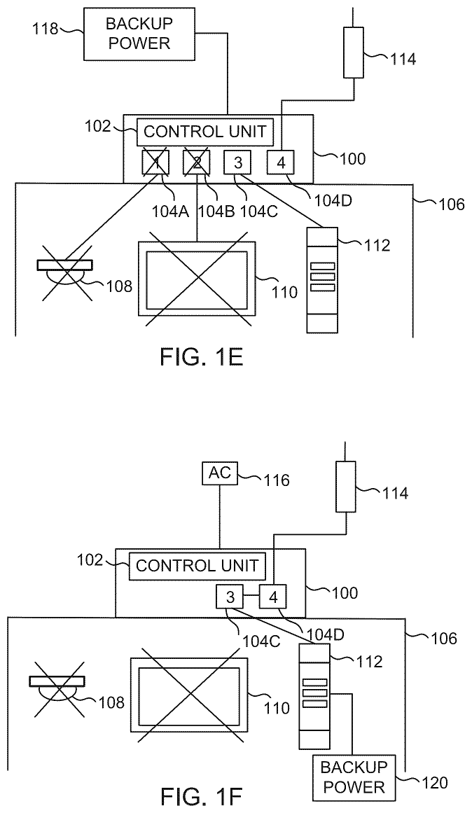

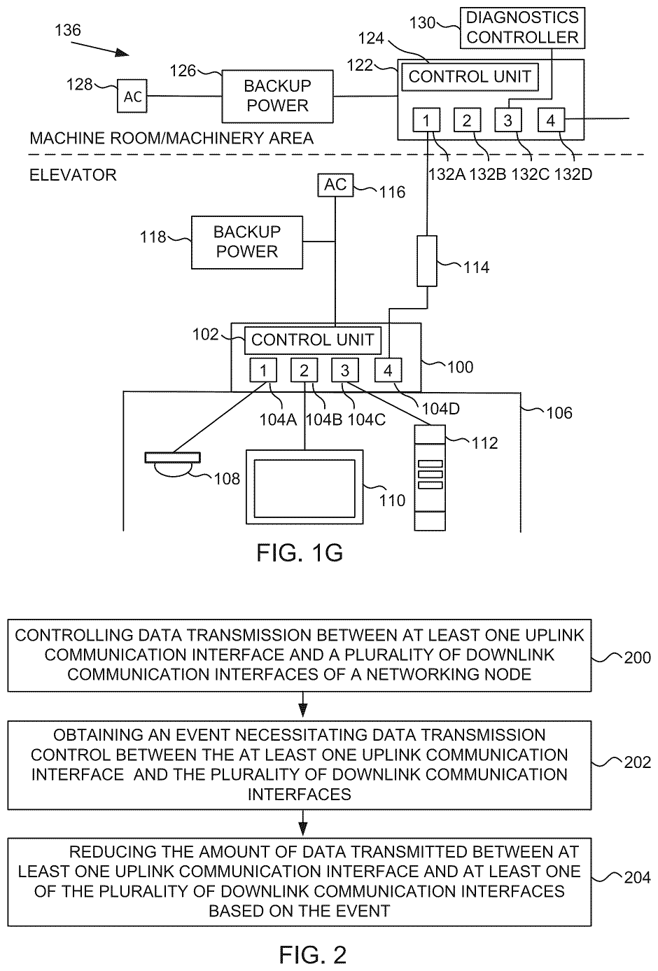

FIG. 1A illustrates a system 134 for a transport system according to an example embodiment. The system 134 may comprise a networking node 100 comprising at least one uplink communication interface 104D and a plurality of downlink communication interfaces 104A-104C, at least one data node 108, 110, 112, wherein one or more data nodes are connected to each of the plurality of downlink communication interfaces 104A-104C. The system may further comprises a control unit 102 communicatively connected to the networking node 100. The control unit 102 may be configured to control data transmission between the at least one uplink communication interface 104D and the plurality of downlink communication interfaces 104A-104C. The control unit 102 may be configured to obtain an event necessitating data transmission control between the at least one uplink communication interface 104D and the plurality of downlink communication interfaces 104A-104C, and reduce the amount of data transmitted or control data transmissions between at least one uplink communication interface and at least one of the plurality of downlink communication interfaces based on the event. The illustrated solution may ensure operability of critical applications and/or devices in case of an operational anomaly of the communication system, for example, a component failure, a power supply failure or a cyber security attack.

In an example embodiment, a single control unit 102 may be configured to control data transmission of a plurality of networking nodes 100 and/or to determine data transmission control instructions for the plurality of networking nodes 100.

In an example embodiment, the various embodiments discussed below may be used in a communication system of a transport system. The transport system may comprise, for example, an elevator, an escalator or a moving walk. The communication system may comprise a unified single protocol stack communication system using a shared communication medium, such that messages from various devices and applications will travel through a shared bus segment or segments. As an example, such a communication system may an ethernet based communication system.

Further, the following description uses the terms “uplink communication interface” and “downlink communication interface”. The uplink communication interface may refer to an interface via which the networking node transmits and receives information to/from another controlling entity. The downlink communication interface may refer to an interface via which the networking node transmits and/or receives information to/from a transport system data node, for example, an intercom device, a media screen, surveillance equipment etc. Further, in the following description, the terms “communication interface” and “port” may be used interchangeably.

In an example embodiment, one or more of the ports 104A-104D may be wireless links providing wireless data transmissions. In an example embodiment, the control unit 102 may be configured to disable/shut down a wireless link when the amount of data transmitted between at least uplink port 104D and at least one of the plurality of downlink communication interfaces 104A, 104B, 104C needs to be reduced based on the obtained event. For example, a wireless link can be shut down in the backup power mode until some critical data needs to be transmitted. In other words, the wireless link may be temporarily activated for a critical data transfer. Non critical data does not open the wireless link.

In another example embodiment, the event may be an external event received by the control unit 102. In another example embodiment, the event may be an internal event associated with the system 134. For example, the control unit 102 may obtain the event from some entity of the system 134. Alternatively, the event may originate from an entity outside the system 134, for example, a diagnostics controller communicatively connected to the control unit 102.

FIG. 1B illustrates a system for a transport system according to an example embodiment. The system comprises networking node 100 that may comprise a control unit 102 configured to control operations of the networking node 100. In an example embodiment, the networking node 100 may be a switch.

In this example embodiment, the networking node 100 comprises four ports 104A-104D. The ports 104A-104C are referred to as “downlink ports” or “downlink communication interface”, and the port 104D is referred to as an “uplink port” or “uplink communication interface”. In another example embodiment, there may be a plurality of uplink ports. The downlink ports 104A-104C may be connected to a variety of data nodes. In this example, the downlink port 104A is connected to a surveillance equipment 108, the downlink port 104B is connected to a media screen 110 and the downlink port 104C is connected to an internet protocol (IP) based intercom device 112. The uplink port 104D may be connected to a communication link comprised in a travelling cable 114. In general, a data node may be a node that mainly only provides information to a passenger (i.e. the networking node 100 mainly only transmits information to the node), a node that mainly only transmits information to the networking node 100, or a node that both transmits and receives information to/from the networking node 100.

The control unit 102 may be configured to obtain an event necessitating data transmission control between the port 104D and ports 104A, 104B, 104C, and reduce the amount of data transmitted between the port 104D and at least one of the ports 104A, 104B, 104C based on the event. For example, this may enable a solution in which the control unit 102 may prioritize data relating to selected devices such that data from/to high-priority devices only is allowed in selected operational situations. In an example embodiment, the event may be an internal event of the system 134. In another example embodiment, the event may be an event or an indication of the event received via the port 104D. Although FIG. 1B illustrates an example in which the networking node 100 and the control unit 102 are located in a single node in an elevator car 106, in another example embodiment, the networking node 100 and/or the control unit 102 may be arranged at a different location in the system. Further, although FIG. 1B illustrated an example applied in an elevator car environment, in another example embodiment, the networking node 100 and/or the control unit 102 may be arranged at a landing or a machinery area. In these cases, the data nodes connected to the networking node 100 may be different than illustrated in FIG. 1B.

In an example embodiment, the system may comprise a memory connected to the control unit 102, the memory storing priority data, and the control unit 102 may be configured to reduce the amount of data transmitted between the port 104D and one or more of the ports 104A, 104B, 104C based on the event and the priority data stored in the memory. In an example embodiment, the memory may be an internal memory of the control unit 102. The memory may also store at least one operational rule to be applied in case the event is obtained. The priority data may define priorities for the ports 104A-104D or priorities assigned to the data nodes 108, 110, 112 connected to the ports 104A-104D. The memory may store, for example the following information:
Port 1 is semi-critical local area network (LAN) application
Port 2 is non-critical LAN application
Port 3 is critical LAN application
Port 4 is an uplink port for a critical LAN application
In a case of an event X, keep the port 1 operational
In a case of the event X, keep the port 3 operational.
In a case of the event X, keep the port 4 operational
In a case of the event X, shut down rest of the ports
In a case of an event X+Y, keep the ports 3 and 4 operational.

In an example embodiment, one or more of the ports 104A-104D may be wireless links providing wireless data transmissions. In an example embodiment, the control unit 102 may be configured to disable/shut down a wireless link when the amount of data transmitted between at least uplink port 104D and at least one of the plurality of downlink communication interfaces 104A, 104B, 104C needs to be reduced based on the obtained event. For example, a wireless link can be shut down in the backup power mode until some critical data needs to be transmitted. In other words, the wireless link may be temporarily activated for a critical data transfer. Non critical data does not open the wireless link.

In another example embodiment, the networking node 100 and the control unit 102 may be separate entities communicatively connected to each other. Further, in an example embodiment, the event may be an external event received by the control unit 102. In another example embodiment, the event may be an internal event associated with the system. For example, the control unit 102 may obtain the event from some entity of the system. Alternatively, the event may originate from an entity outside the system, for example, a diagnostics controller communicatively connected to the control unit 102.

FIG. 1C illustrates a system for a transport system according to another example embodiment. The example illustrated in FIG. 1C is similar to the one illustrated in FIG. 1B, and the above discussion relating to the example of FIG. 1B applies also to the example of FIG. 1C.

FIG. 1C additionally illustrates that there is a normal power source 116 and a backup power 118 connected to the networking node 100. The backup power 118 may provide operating power in case the normal power source 116 fails for some reason.

FIG. 1D illustrates a system for a transport system according to another example embodiment. The example illustrated in FIG. 1D may follow, when there is a failure with the normal power source 116. This may cause a situation in which power to the networking node 100 is provided by the backup power 118. The information stored in the memory may now provide the following actions:
In a case of backup powering, keep the port operational
In a case of backup powering, keep the port 3 operational
In a case of backup powering, keep the port 4 operational
In a case of backup powering, shut down rest of the ports.

As illustrated in FIG. 1D, the media screen 104B is shut down in order to reduce the amount of data transmitted between the port 104D and the ports 104A, 104B, 104C.

FIG. 1E illustrates a system for a transport system according to another example embodiment. The example illustrated in FIG. 1E may follow, for example, when there is a certain amount of backup power (or less) left in the backup power 118. The information stored in the memory may now provide the following additional actions:
In a case of 50% or less backup power left, shut down the port 1
In a case of 50% or less backup power left, keep the port 3 operational
In a case of 50% or less backup power left, keep the port 4 operational.

FIG. 1F illustrates a system for a transport system according to another example embodiment. The example illustrated in FIG. 1F may follow, for example, when there is a total power loss or a hardware failure associated with the networking node 100. The information stored in the memory may now provide the following additional actions:
In a case of a total power loss or a hardware failure, bypass the port 3 to the port 4.

In an example embodiment, there may an additional backup power 120 associated with a critical data node (i.e. the data node 112 in FIG. 1D) enabling the data node 120 and/or the networking node 100 to operate in case of the total power loss or hardware failure.

FIG. 1G illustrates a communication system 136 for a transport system according to another example embodiment. The example illustrated in FIG. 1G illustrates a networking node 122 associated with a machinery area. The operations discussed above relating to the networking node 100 may apply similarly also for the networking node 122. In other words, one or more ports 132A-132D may be designated as downlink ports and one or more ports 132A-132D may be designated as uplink ports. Each port 132A-132D may have a priority associated with them. There may a normal power source 128 and a backup power 126 connected to the networking node 122. In an example embodiment, the networking node 122 may comprise a memory storing priority data, and a control unit 124 may be configured to reduce the amount of data transmitted between the port 132D and one or more of the ports 132A, 132B, 132C based on the event and the priority data stored in the memory. The memory may also store at least one operational rule to be applied in case the event is obtained. The priority data may define priorities for the ports 132A-132D or priorities assigned to nodes or entities connected to the ports 132A-132D. The memory may store, for example the following information:
Port 1 is a critical LAN application
Port 2 is non-critical
Port 3 is non-critical
Port 4 is an uplink port for a critical LAN application
In a case of backup powering from the backup power 126, keep the ports 1 and 4 operational
In a case of 50% or less backup power left, keep the ports 1 and 4 operational
In a case of a total power loss or a hardware failure, bypass the port 1 to the port 4.

In an example embodiment, the communication system may comprise a diagnostics controller 130. The diagnostics controller 130 may be connected to a port of the networking node 122. Alternatively, the diagnostics controller 130 may be communicatively reachable by the networking node 122 through the port 132D. Thus, the diagnostics controller may be an internal element of the communication system an or external element communicatively connected to the communication system. In an example embodiment, the networking node 100 and/or the networking node 122 may be configured to receive the event or an indication of the event via the port 104D, 132D. The indication may indicate, for example, an operational status of the communication system. In another example embodiment, the control unit 102, 124 may be configured to obtain the event based on a power failure indication obtained from the diagnostics controller 130. The diagnostics controller 130 may be a separate controller or integrated into an existing controller. For example, the diagnostics controller 130 may be a diagnostics application program executed by an existing controller of the transport system. In response to the event or indication from the diagnostics controller 130, the control unit 102, 124 is able to reduce the amount of data transmitted between the ports, for example, by reducing data transfer from/to lower priority ports or data nodes.

FIG. 1G illustrates an embodiment in which the diagnostics controller 130 may be a separate entity connected, for example, to the networking node 124. In another example embodiment, the diagnostics controller may be integrated with the control unit 102, 122 or with the networking node 100, 122. The diagnostics controller 130 may be configured to detect an abnormal situation based on learned data associated with normal situation behavior. The reduction in the amount of transmitted data may be based on the detection.

In an example embodiment, the diagnostics controller 130 may be configured to determine priorities for communication of various data nodes, for example, by using a Link Layer Discovery Protocol (LLDP) query directed to the data nodes. The operational rules stored in the control unit 102, 124 or in the memory may be based on the priorities such that high-priority communication may be allocated for selected devices, for example, intercom devices using voice and/or video communication over the communication system. In case of an operational anomaly, the control unit 102, 124 may ensure that the high-priority communication is possible by reducing communication (or alternatively interrupting communication) from lower-priority devices in the communication system.

In an example embodiment, the diagnostics controller 130 may be configured to determine a communication overload in the communication system caused by, for example, a security attack in the communication system. The diagnostics controller 130 may be configured to transmit an indication of the communication overload to the control unit 102, 124 to enable to reduce data transfer between the ports of the networking node 100, 122 as already discussed above. This enables a solution in which the diagnostics controller 130 is able to ensure data transfer relating to critical applications in a network overload situation.

In an example embodiment the control unit 102, 124 may be configured to reduce the amount of data transmitted between the uplink communication interface and at least one of the plurality of downlink communication interfaces periodically. This may be applied, for example, when transmitting images or real-time data steam. For example, if there is a passenger or some other object in an elevator car and the event necessitating data transmission control is obtained, the amount of data transmitted may be reduced by controlling the periods on which data is transmitted. For example, a still image may be transmitted in every 30 seconds or any other predetermined time interval.

FIG. 2 illustrates a method for a communication system of a transport system comprising an elevator, an escalator or a moving walk according to an example embodiment. The method may be performed, for example, by the control unit 102 or the control unit 124.

At 200 the method may comprise controlling, by a control unit, data transmission between at least one uplink communication interface and a plurality of downlink communication interfaces.

At 202 the method may comprise obtaining, by the control unit, an event necessitating data transmission control between the at least one uplink communication interface and the plurality of downlink communication interfaces.

At 204 the method may comprise reducing or controlling, by the control unit, the amount of data transmitted between at least one uplink communication interface and at least one of the plurality of downlink communication interfaces based on the event.

One or more of the examples and embodiments discussed above may enable a solution in which data transmissions can be prioritized, for example, in a power failure event, in a limited power situation or any other event causing challenges for maintaining normal data transmissions. Further, one or more of the examples and embodiments discussed above may enable a solution in which it is possible to maintain a transport system service, for example, an elevator service, longer or as long as possible in an operational anomaly of the transport system or the communication system of the transport system. Further, one or more of the examples and embodiments discussed above may enable a solution in which it is possible to ensure the possibility of making an emergency call or an emergency video call from an elevator car without arranging, for example, separate backup power sources. Further, one or more of the examples and embodiments discussed above may enable a solution in which a single common communication bus can be used between transport system nodes as the illustrated solution may provide actions that can be applied in a case of an operation anomaly in the transport system or the communication system of the transport system.

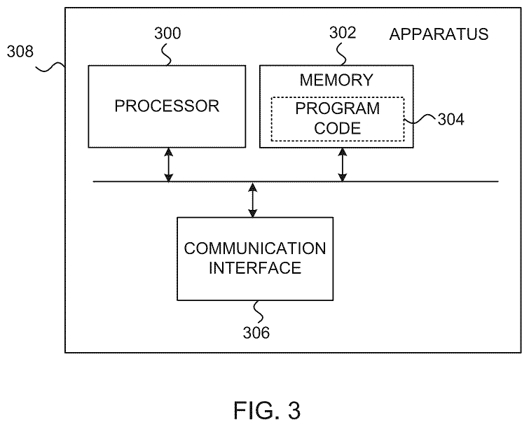

FIG. 3 illustrates an example of an apparatus 308 configured to practice one or more example embodiments. The apparatus 308 may comprise at least one processor 302. The at least one processor 302 may comprise, for example, one or more of various processing devices or processor circuitry, such as, for example, a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 308 may further comprise at least one memory 304. The at least one memory 304 may be configured to store, for example, computer program code or the like, for example, operating system software and application software. The at least one memory 304 may comprise one or more volatile memory devices, one or more non-volatile memory devices, and/or a combination thereof. For example, the at least one memory 304 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 308 may further comprise a communication interface 306 configured to enable apparatus 308 to transmit and/or receive information to/from other devices. In one example, the apparatus 308 may use the communication interface 306 to transmit or receive signaling information and data in accordance with at least one data communication protocol. The communication interface 306 may be configured to provide one or more types of connections, for example a wireless local area network (WLAN) connection such as for example standardized by IEEE 802.11 series or Wi-Fi alliance; a wired connection, for example, a local area network (LAN) connection, or an optical network connection, or the like. The communication interface 306 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

When the apparatus 308 is configured to implement some functionality, some component and/or components of the apparatus 308, for example, the at least one processor 302 and/or the at least one memory 304, may be configured to implement this functionality. Furthermore, when the at least one processor 302 is configured to implement some functionality, this functionality may be implemented using the program code 306 comprised, for example, in the at least one memory 304.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), and Graphics Processing Units (GPUS).

The apparatus 308 may comprise means for performing at least one method described herein. In an example embodiment, the means may comprise the at least one processor 302, the at least one memory 304 including program code 306 configured to, when executed by the at least one processor, cause the apparatus 308 to perform the method. Although the apparatus 308 is illustrated as a single device it is appreciated that, wherever applicable, functions of the apparatus 308 may be distributed to a plurality of devices.

An apparatus, for example, the apparatus 308 may be configured to implement networking node 100, the networking node 122, the control unit 102 or the control unit 124, and it may be configured to perform or cause performance of any aspect of the method (s) described herein. Further, a computer program may comprise instructions for causing, when executed, an apparatus to perform any aspect of the method (s) described herein. Further, an apparatus may comprise means for performing any aspect of the method (s) described herein. According to an example embodiment, the means comprises at least one processor, and at least one memory including program code, the at least one processor, and program code configured to, when executed by the at least one processor, cause performance of any aspect of the method (s).

Example embodiments may be implemented in software, hardware, application logic or a combination of software, hardware and application logic. The example embodiments can store information relating to various methods described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

All or a portion of the example embodiments can be conveniently implemented using one or more general purpose processors, microprocessors, digital signal processors, micro-controllers, and the like, programmed according to the teachings of the example embodiments, as will be appreciated by those skilled in the computer and/or software art (s). Appropriate software can be readily prepared by programmers of ordinary skill based on the teachings of the example embodiments, as will be appreciated by those skilled in the software art. In addition, the example embodiments can be implemented by the preparation of application-specific integrated circuits or by interconnecting an appropriate network of conventional component circuits, as will be appreciated by those skilled in the electrical art (s). Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A system for a transport system comprising an elevator, an escalator or a moving walk, the system comprising:
a networking node comprising at least one uplink communication interface and a plurality of downlink communication interfaces;
at least one data node, wherein one or more data nodes are connected to each of the plurality of downlink communication interfaces; and
a control unit communicatively connected to the networking node, wherein the control unit is configured to:
control data transmission between the at least one uplink communication interface and the plurality of downlink communication interfaces;
obtain an event necessitating data transmission control between the at least one uplink communication interface and the plurality of downlink communication interfaces; and
reduce the amount of data transmitted between at least one uplink communication interface and at least one of the plurality of downlink communication interfaces based on the event.

2. The system of claim 1, wherein the event is an external event received by the control unit.

3. The system of claim 1, wherein the event in an internal event associated with the system.

4. The system of claim 1, wherein the control unit is configured to:
obtain the event from a diagnostics controller.

5. The system of claim 1 wherein the event is a power supply failure.

6. The system of claim 1, wherein the control unit is configured detect a state of a backup battery associated with the system and to reduce the amount of data transmitted between at least one uplink communication interface and at least one of the plurality of downlink communication interfaces based on the state of the backup battery.

7. The system of claim 6, wherein the backup battery is an internal battery of the networking node.

8. The system of claim 1, further comprising:
a memory connected to the control unit, the memory being configured to store priority data,
wherein the control unit is configured to reduce the amount of data transmitted between at least one uplink communication interface and at least one of the plurality of downlink communication interfaces based on the event and the priority data stored in the memory.

9. The system of claim 8, wherein the priority data comprises a specific priority assigned to each downlink communication interface.

10. The system of claim 8, wherein the priority data comprises a specific priority assigned to each data node.

11. The system of claim 8, wherein the control unit is configured to:
receive the priority data from a diagnostics controller.

12. The system of claim 1, wherein the control unit is configured to:
interrupt data transmission between at least one of the plurality of downlink communication interfaces and at least one uplink communication interface.

13. The system of claim 1 wherein the plurality of downlink communication interfaces are configured in at least two modules, and the control unit is configured to reduce the amount of data transmitted between at least one uplink communication interface and at least one of the plurality of downlink communication interfaces based on the event by module basis.

14. The system of claim 1, wherein the control unit is configured to reduce the amount of data transmitted between at least one uplink communication interface and at least one of the plurality of downlink communication interfaces periodically.

15. The system of claim 1, wherein the at least one data node comprises an intercom device, a media screen, a surveillance equipment, a node that mainly provides information to a passenger, a node that mainly transmits information, and a node that both transmits and receives information.

16. The system of claim 1, wherein the networking node is arranged in an elevator car and an uplink communication interface is connected to a communication bus segment arranged in a travelling cable.

17. The system of claim 16, wherein the control unit is configured to:
obtain information indicating a presence of an object in the elevator car; and
take the presence of the object in the elevator car into account when reducing the amount of data transmitted between at least one uplink communication interface and at least one of the plurality of downlink communication interfaces.

18. The system of claim 1, wherein an uplink communication interface comprises a wireless uplink communication interface.

19. The system of claim 1, wherein a downlink communication interface comprises wireless downlink communication interface.

20. The system of claim 19, wherein the control unit is configured to disable the wireless downlink communication interface when the amount of transmitted data needs to be reduced based on the obtained event.

21. A communication system of a transport system comprising an elevator, an escalator or a moving walk, the communication system comprising:
the system of claim 1.

22. The communication system of claim 21, further comprising:
a diagnostics controller communicatively connected to the control unit.

23. The communication system of claim 22, wherein the diagnostics controller is configured to:
determine a power failure associated with the communication system; and
transmit an indication of the power failure to the system.

24. The communication system of claim 22, wherein the diagnostics controller is configured to:
determine priorities associated with the at least one data node; and
transmit the priorities to the control unit for storing by the control unit.

25. The communication system of claim 22, wherein the diagnostics controller is configured to:
determine a communication overload in the communication system; and
transmit an indication of the communication overload to the control unit.

26. A transport system comprising the communication system of claim 21, wherein the transport system comprises an elevator, an escalator or a moving walk.

27. A method for a communication system of a transport system comprising an elevator, an escalator or a moving walk, the method comprising:
controlling, by a control unit, data transmission between at least one uplink communication interface and a plurality of downlink communication interfaces of a networking node;
obtaining, by the control unit, an event necessitating data transmission control between the at least one uplink communication interface and the plurality of downlink communication interfaces; and
reducing, by the control unit, the amount of data transmitted between at least one uplink communication interface and at least one of the plurality of downlink communication interfaces based on the event.

28. A computer program embodied on a non-transitory computer readable medium and comprising instructions for causing a control unit to perform at least the following:
controlling data transmission between at least one uplink communication interface and a plurality of downlink communication interfaces of a networking node;
obtaining an event necessitating data transmission control between the at least one uplink communication interface and the plurality of downlink communication interfaces; and
reducing the amount of data transmitted between at least one uplink communication interface and at least one of the plurality of downlink communication interfaces based on the event.
